(19) United States
(12) Patent Application Publication
(10) Pub. No.: US 2010/0111642 A1
(43) Pub. Date: May 6, 2010

(54) CLIP FOR ATTACHING A COVER OR OTHER ATTACHING MEMBER

(75) Inventor: Hiroto MATSUNO, Toyohashi-shi (JP)

Correspondence Address: THE BLACK & DECKER CORPORATION, 701 EAST JOPPA ROAD, TW199, TOWSON, MD, 21286, US

(73) Assignee: NEWFREY LLC, Newark, DE (US)

(21) Appl. No.: 12/612,998

(22) Filed: Nov. 5, 2009

(30) Foreign Application Priority Data
Nov. 5, 2008 (JP) 2008-284091

(51) Int. Cl. F16B 19/00

(52) U.S. Cl. 411/508

(57) ABSTRACT

A clip including a stud engagement part which is configured to receive a stud. The stud engagement part has a first end with a stud receiving opening and a second end with a flange. A pair of retainer pieces extend from the stud engagement part near the second end of the stud engagement part. An elastic piece extends diagonally from an end of the retainer piece, the elastic piece being longer than the retainer piece.

### CROSS-REFERENCE TO RELATED APPLICATIONS

This application claims the benefit of Japanese Application No. 2008-284091 filed Nov. 5, 2008, the disclosure of which is incorporated herein by reference.

### TECHNICAL FIELD

The present invention relates to a clip that can be used to attach an attaching member, such as a cover, to a member being attached to, such as a vehicle body panel.

### BACKGROUND TECHNOLOGY

Clips used for attaching an attaching member, such as a cover, to a member being attached to, such as a vehicle body panel, are described in Patent Literature 1 and Patent Literature 2. These clips, which are described in gazettes or the like, comprise cylindrical stud engagement parts for receiving studs erected on members being attached to, such as vehicle body panels, and for engaging those studs, flanges provided on the ends of the stud engagement parts opposite the stud receiving ends thereof and retainer pieces that extend outwardly in the radial direction from positions near the flanges of the stud engagement parts, which retainer pieces are formed in such lengths as will pull out from auxiliary channels formed continuously with attachment holes in the attaching members and extending outwardly in the radial direction thereof, being of such lengths also as to not pull out from said attachment holes, which clips are configured so as to clamp the attachment members between the retainer pieces and the flanges and thereby support the attaching members, with which, by engaging the stud engagement parts with the studs, the attaching members are attached to the members being attached to.

Patent Literature 1: TOKKAI [Unexamined Pat. Appln.] No. 2007-285319 (Gazette)

Patent Literature 2: TOKKAI No. 2008-128319 (Gazette)

In the clip described in Patent Literature 1, in order to prevent the stud engagement part engaged with a screw-threaded stud from turning in the releasing direction, a turning prevention piece that engages an auxiliary channel formed on the outside of the attachment hole is formed in the outer circumference of the stud engagement part, and in order to prevent play in the attaching member clamped between the flange and the retainer piece, a pressing piece for elastically pressing the attaching member toward the retainer piece is formed in the flange. Accordingly, in this clip, the pressing piece and turning prevention piece must be formed in order to prevent play and prevent turning. Also, when the stud engagement part is turned in the tightening direction in an attempt to make the engagement force of the stud engagement part to the screw-threaded stud stronger, the turning prevention piece for preventing turning may hinder that turning.

In the clip described in Patent Literature 2, the stud engagement part is given a unique configuration in order to strengthen the engagement force to the screw-threaded stud, while lightening the force required for insertion to the screw-threaded stud, but the configuration for preventing the turning of the stud engagement part and preventing play is the same as that of the clip of Patent Literature 1. That is, a turning prevention piece for engaging an auxiliary channel is formed in the outer circumference of the stud engagement part, and in order to prevent play in the attaching member, a pressing piece for elastically pressing the attaching member in the direction of the retainer piece is formed in the flange. Accordingly, in this clip also, the pressing piece and turning prevention piece is used to prevent play and prevent turning. Also, even if the stud engagement part is turned in the direction of tightening in an attempt to strengthen the engagement force of the stud engagement part to the screw-threaded stud, the turning prevention piece for preventing turning may hinder that turning.

Although potential disadvantages of the related art patent literature are described herein, the present application does not necessarily exclude particular features of this related art such as the above-described turning prevention piece described above from the scope of exemplary embodiments of the present invention.

### SUMMARY OF THE INVENTION

According to one aspect of the invention, there is a clip including a cylindrical stud engagement part for receiving a stud erected on an attaching member and engaging that stud;

a flange provided at an end of said stud engagement part opposite a stud receiving end of said stud engagement part; and

retainer pieces that extend outwardly in the radial direction from positions near said flange of said stud engagement part;

wherein the retainer pieces are formed in such lengths as will pull out from auxiliary channels formed continuously with an attachment hole in the attaching member and extending outwardly in the radial direction thereof, being of such lengths also as will not pull out from said attachment hole;

said clip being configured so as to clamp the attachment member between said retainer pieces and said flange and thereby support the attaching member, and so that the stud engagement part engages the stud and thereby attaches the attaching member to a member being attached to; wherein:
i. in said retainer pieces, on the sides facing said flange, elastic pieces are formed which extend out diagonally from said retainer pieces toward said flange, which elastic pieces elastically engage the attaching member and present a force that resists the turning of said stud engagement part about the axis thereof.

The clip may include retainer pieces formed as a pair, on the outer circumferential surface of the sides of said stud engagement part, each positioned 180 degrees apart about the outer circumference.

The clip may include retainer pieces formed on the sides of said stud engagement part as plate-form members, each of a length that is shorter than the length of said auxiliary channel, in the circumferential direction and the elastic pieces may be formed in cantilever shapes such that, in said circumferential direction, each is continuous at one end of said retainer piece, and extends from that one end of said retainer piece toward the other end so as to separate away from that retainer piece and approach said flange.

The elastic pieces may be formed so that the length thereof in said circumferential direction is longer than that of said retainer piece and also longer than the width of said auxiliary channel; and whereupon, when, after said stud engagement part has been inserted into the attachment hole of the attaching member, said retainer pieces have been passed through said auxiliary channels and said flange has been pressed in to a position at which it is flush against the attaching member, said stud engagement part is then turned about the axis thereof, said elastic pieces extending from said retainer pieces come up against the attaching member, the elastic pieces overall furthermore come up against said attaching member, so that they are thus bent in such attitude as to come up against said retainer pieces, and said elastic pieces are held in positions from which they cannot pull out from said auxiliary channels.

In said flange, finger grips may be formed for turning said stud engagement part about the axis thereof.

The flange may be cut out in the areas where said retainer pieces and said elastic pieces are formed, as seen in a plan view of the clip, and said retainer pieces and said elastic pieces can be directly viewed in said plan view.

The flange may be provided at the upper end of said stud engagement part; wherein said retainer pieces and said elastic pieces are provided at the sides of said stud engagement part at positions that are separated from said flange by a distance corresponding to the thickness of the attaching member; and a stud receiving opening is formed at the lower end of said stud engagement part.

The member being attached to may be a vehicle body panel, and the attaching member is a cover for covering that panel.

According to another aspect of the invention, there is a clip including a stud engagement part configured to receive a stud, the stud engagement part having a first end with a stud receiving opening and a second end with a flange; wherein a pair of retainer pieces extend from the stud engagement part near the second end of the stud engagement part; and wherein an elastic piece extends diagonally from an end of the retainer piece, the elastic piece being longer than the retainer piece.

The flange may comprise two flange portions with spaces between ends of the flange portions; and the retainer and elastic pieces may be located substantially in the area defined by the spaces.

The retainer pieces may be substantially parallel to the flange portions, wherein the elastic pieces extend towards a plane in which the flange lies and wherein ends of the elastic pieces extend beyond the plane of the flange.

The clip may further include ribs which are connected to the stud engagement part and the retainer pieces and serve to support the retainer pieces

The clip may further include finger grips extending axially from the flange pieces.

The stud engagement part may be substantially cylindrical; and the engagement pawls may extend inwardly from an inner circumferential surface of the stud engagement part.

According to another aspect, there is a fastener assembly, including a clip, the clip comprising a stud engagement part configured to receive a stud, the stud engagement part having a first end with a stud receiving opening and a second end with a flange; and a first member, the first member comprising an attachment hole and auxiliary channels formed continuously with and outwardly in a radial direction from the attachment hole; wherein a pair of retainer pieces extend from the stud engagement part near the second end of the stud engagement part; wherein an elastic piece extends diagonally from an end of the retainer piece at least when in a relaxed state, the elastic piece being longer than the retainer piece; wherein the clip is inserted into the first member with the retainer piece on a first side of the first member and the flange on a second side of the first member; and wherein the auxiliary channels have a length which is greater than a length of the retainer pieces and which is shorter than a length of the elastic pieces.

The fastener assembly may further include a second member, the stud attached to and extending from the second member; wherein the stud is engaged with the stud engagement portion of the clip.

The attachment hole may be generally circular and the auxiliary channels are substantially rectangular shaped channels extending from the circumference of the attachment hole.

The clip may be configured so as to clamp the attachment member between said retainer pieces and said flange; wherein the length of the retainer pieces is such that the retainer pieces will pull out from the auxiliary channels and will not pull out from the attachment hole.

The elastic pieces elastically engage the attaching member and present a force that resists the turning of said stud engagement part about the axis thereof.

### BRIEF DESCRIPTION OF THE DRAWINGS

FIG. 1 is a plan of a clip relating to one exemplary embodiment of the present invention.

FIG. 2 is a front elevation of the clip diagrammed in FIG. 1.

FIG. 3 is a right side elevation of the clip diagrammed in FIG. 2.

FIG. 4 is a partial diagonal view of an attaching member.

FIG. 5 is a diagram of the clip of FIG. 2 positioned on an attaching member.

FIG. 6 is a bottom view of the attaching member and clip diagrammed in FIG. 5.

FIG. 7 is a plan of the attaching member and clip diagrammed in FIG. 5.

FIGS. 8A to 8D are sections diagramming how the relationships between the retainer pieces, elastic pieces, and auxiliary channels are changed by turning the stud engagement part.

FIG. 9 is a diagram of the clip of FIG. 2 attached to an attaching member.

FIG. 10 is a bottom view of the attaching member and clip diagrammed in FIG. 9.

FIG. 11 is a diagram of how the clip diagrammed in FIG. 2 attaches an attaching member to a member being attached to.

### DETAILED DESCRIPTION OF EXEMPLARY EMBODIMENTS OF THE INVENTION

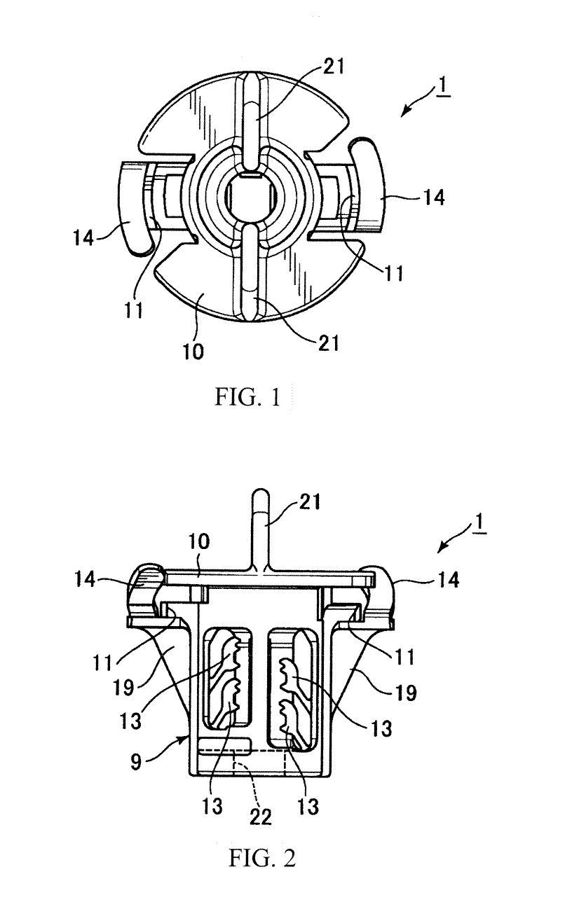

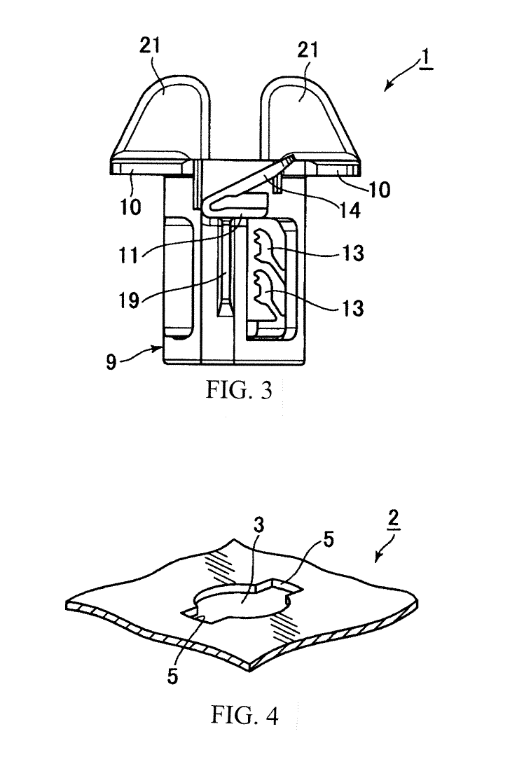

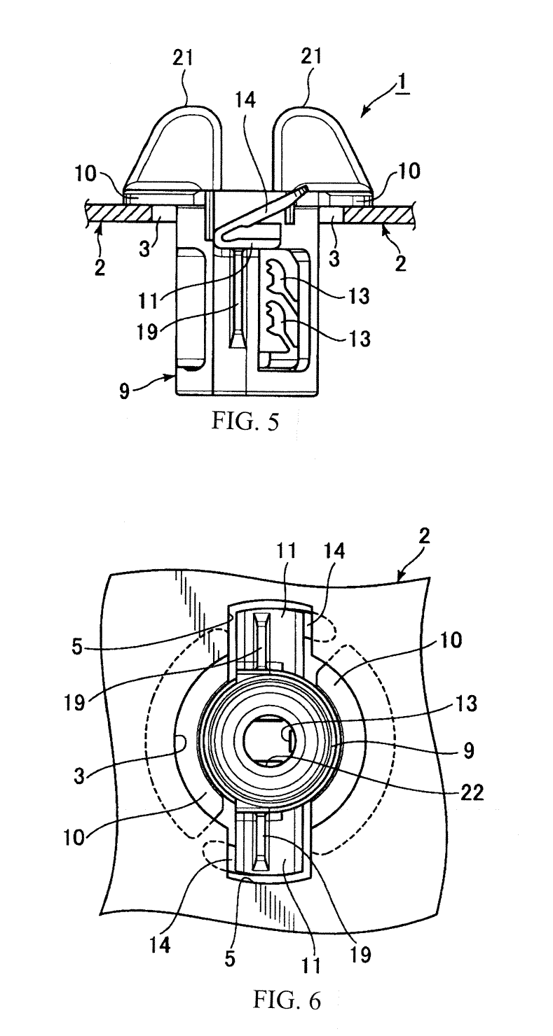

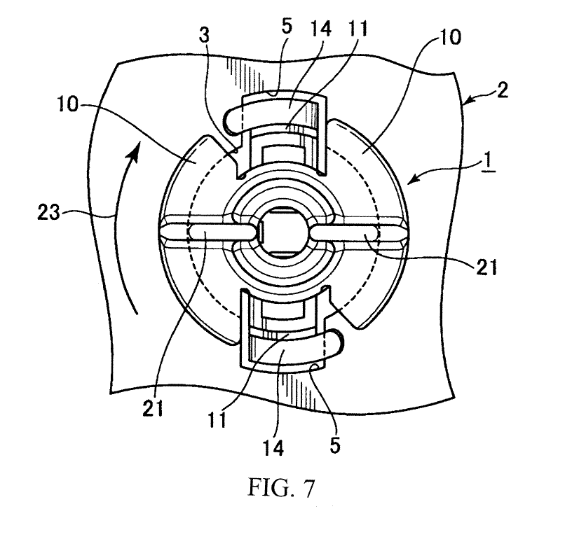

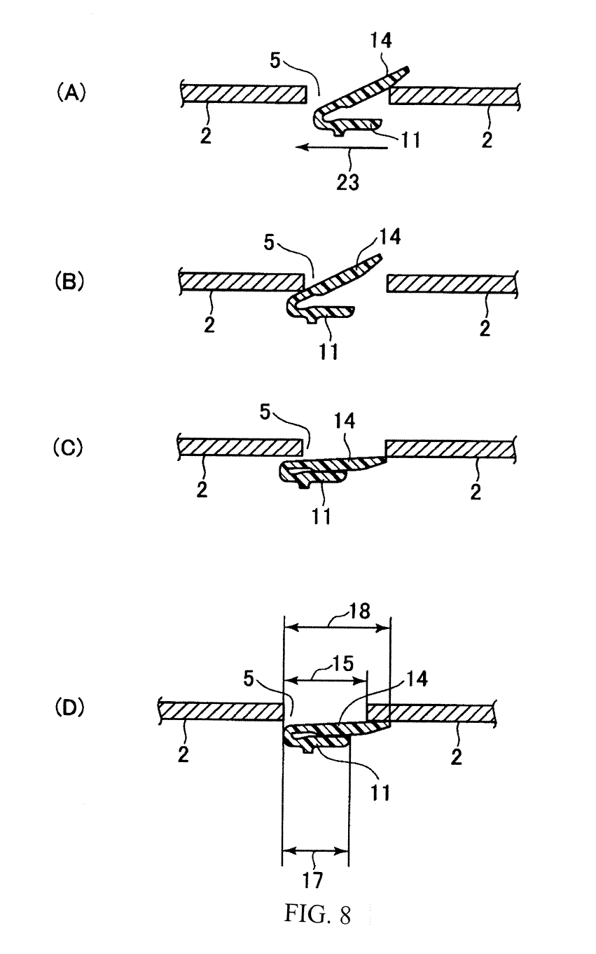

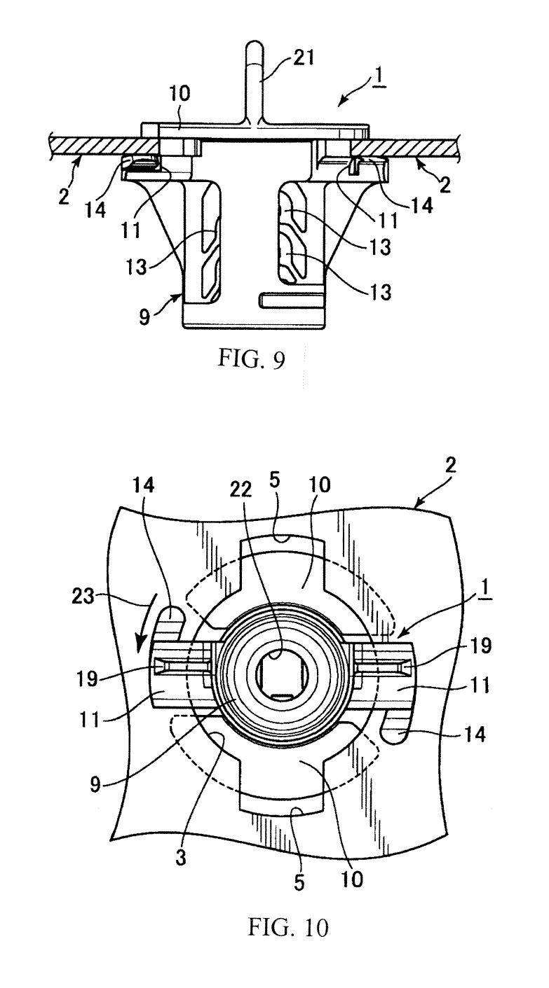

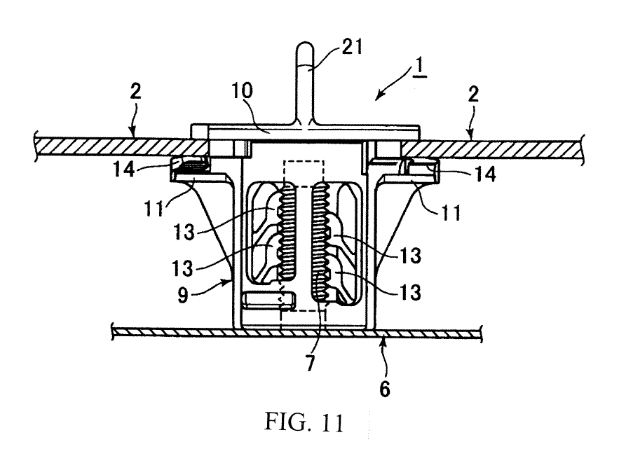

A clip 1 relating to one exemplary embodiment of the present invention is now described with reference to the drawings. The configuration of the clip 1 is diagrammed in FIGS. 1 to 3. FIG. 4 represents a portion of an attaching member 2 such as a cover for covering a vehicle body panel, diagramming the portion of the attaching member where an attachment hole 3, and auxiliary channels 5 formed continuously with and outwardly in the radial direction from the attachment hole 3, are formed. FIGS. 5 and 6 diagram how the clip 1 is positioned on the attaching member 2 prior to attachment. FIG. 7 diagrams the procedure of attaching the clip 1 to the attaching member 2. FIGS. 8A to 8D diagram the relationships among the auxiliary channels, the retainer pieces and the elastic pieces during the series of procedures for attaching the clip 1 to the attaching member 2. FIGS. 9 and 10 diagram the condition after the clip 1 has been attached to the attaching member 2. FIG. 11 diagrams how the attaching member 2 is attached to a member being attached to 6 by engaging the attaching member 2 held by the clip 1 to a stud (that being a screw-threaded stud in the example diagrammed) 7 erected on the member being attached to 6, such as a vehicle body panel.

The clip 1 shall now be described in detail, with reference to FIGS. 1 to 3. The clip 1 is integrally formed of a plastic material. The clip 1 comprises a cylindrical stud engagement part 9 that receives a stud erected on the member being attached to, and engages that stud, a flange 10 provided on the end of the stud engagement part 9 opposite the stud receiving end thereof, and a pair of retainer pieces 11 that extend outward in the radial direction of the stud engagement part 9 from positions near the flange 10. The stud engagement part 9 is formed in a hollow cylindrical shape, inside of which are formed multiple pairs of engagement pawls 13 for engaging the threads formed in the stud, so as to form many steps in the radial direction of the stud engagement part 9.

The retainer pieces 11 are formed as a pair in the outer circumferential surface on the sides of the stud engagement part 9, at positions that are 180 degrees apart in the circumferential direction. In this way, the retention effect is made definite. Each retainer piece 11 is formed to a length that will pull out from the auxiliary channels 5 in the attaching member but will not pull out from the attachment hole 3 therein, being formed as a rigid plate-form member in the side of the stud engagement part 9, to a length that is shorter than the length of the auxiliary channel 5 as seen in the circumferential direction. In each of the retainer pieces 11, on the side facing the flange 10, an elastic piece 14 is formed which extends diagonally from the retainer piece 11 toward the flange 10. The elastic pieces 14 are formed as a pair, corresponding to the pair of retainer pieces 11, being formed in cantilever shapes, continuous with one end of a retainer piece 11 and extending from that one end of the retainer piece 11 toward the other end so as to separate from the retainer piece 11 and approach the flange 10. In this way, the retainer pieces 11 elastically engage the attaching member 2 and provide a force that resists the turning of the stud engagement part 9 engaged with the stud 7 about the axis thereof. Furthermore, because they are of a cantilever shape, the elastic pieces 14 lessen the force required by a worker when turning the stud engagement part 9 about the axis thereof while at the same time keep the elastic force of the elastic pieces 14 high.

The elastic pieces 14 are each formed so that its length, as seen in the circumferential direction as relating to the stud engagement part 9, is longer than the retainer piece 11 and also longer than the width of the auxiliary channel 5. The relationships among the lengths of the elastic pieces 14, the lengths of the retainer pieces 11 and the widths of the auxiliary channels 5 are diagrammed in FIG. 8D. Relative to the width 15 of the auxiliary channel 5, the length 17 in the circumferential direction of the retainer piece 11 is formed shorter, so that the retainer piece 11 can easily pass through the auxiliary channel 5, while the length 18 in the circumferential direction of the elastic piece 14 is formed longer than the retainer piece 11 and also longer than the width 15 of the auxiliary channel 5. In this way, the elastic pieces 14 that have been inserted into the auxiliary channels 5 after the turning of the stud engagement part 9 about its axis will no longer pull out from the auxiliary channels 5. In the embodiment diagrammed, moreover, on the outer sides of the stud engagement part 9, ribs 19 are formed which extend in the axial direction so as to enhance the rigidity of the retainer pieces 11.

In the flange 10, finger grips 21 are formed for turning the stud engagement part 9 about the axis thereof. The finger grips 21 are formed in a pair of butterfly wing shapes so as to facilitate a worker's gripping it. Also, as diagrammed in FIG. 1, the flange 10 is cut out in areas where the retainer pieces 11 and elastic pieces 14 are formed, as seen in a plan view of the clip 1. This not only facilitates the die punching for forming the retainer pieces 11 and the elastic pieces 14, but, in this way, when the clip 1 is being positioned on the attaching member 2, the retainer pieces 11 and elastic pieces 14 can be directly viewed in a plan view, thus making the work of attaching the clip 1 to the attaching member 2 easy. In the embodiment diagrammed, furthermore, the flange 10 is provided at the upper end of the stud engagement part 9, the retainer pieces 11 and elastic pieces 14 are provided on the sides of the stud engagement part 9 at positions separated from the flange 10 by a distance corresponding to the thickness of the attaching member, and the stud receiving opening 22 is formed at the lower end of the stud engagement part 9. In this way, the work of attaching the attaching member 2 clamped by the flange 10, on the one hand, and the retainer pieces 11 and elastic pieces 14, on the other, through the stud 7 to the member being attached to 6, can easily be accomplished by the operation of pressing the clip 1 into the stud 7 from one side.

The attaching member 2 is a cover, such as an undercover for covering a vehicle body panel. In the attaching member 2, as diagrammed in FIG. 4, an attachment hole 3 for attaching the clip 1 and a pair of auxiliary channels 5 that are formed continuously with the attachment hole 3, outwardly in the radial direction thereof, are formed. The material of the attaching member 2 may be plastic or metal.

The operation of attaching the clip 1 to the attaching member 2 is now described with reference to FIGS. 5 to 10. First, with the clip 1, as diagrammed in FIGS. 5 and 6, the stud engagement part 9 is inserted into the attachment hole 3 of the attaching member 2 and pressed in to a position at which the pair of retainer pieces 11 passes through the auxiliary channels 5 and the flange is flush against the attaching member. After this pressing in, the finger grips 21 of the flange are gripped by the fingers, whereupon the flange 10 and thus the stud engagement part 9 is turned about the axis thereof, as indicated by the arrow 23 in FIG. 7. By this turning, the elastic pieces 14 extending from the retainer pieces 11 are made to come up against the attaching member 2. How this works is diagrammed in FIGS. 8A to 8C. The position diagrammed in FIG. 8A is the initial positioning position for the clip 1, as diagrammed in FIGS. 5 to 7. When the stud engagement part 9 is turned in the direction of arrow 23 in FIG. 7, each of the elastic pieces 14 begins to come up against the attaching member 2 at the end made continuous with the retainer piece 11, as diagrammed in FIG. 8B. When the stud engagement part 9 is turned further, as diagrammed in FIG. 8C, each of the elastic pieces 14 overall is bent, by coming up against the attaching member 2, to such attitude that it comes up against the retainer piece 11, and the elastic pieces 14 are held in positions from which they cannot pull out from the auxiliary channels 5. In this way, the clip 1 is retained in the attaching member 2, and that retention is definitely maintained.

FIG. 8D diagrams how the retainer piece 11 and elastic piece 14 cannot pull away, even when in or near the position diagrammed in FIG. 8C. As already described, each of the elastic pieces 14 is formed to a length, as seen in the circumferential direction relative to the stud engagement part 9, that is longer than the retainer piece 11 and also longer than the width of the auxiliary channel 5. That being so, the elastic pieces 14 overall are bent, by coming up against the attaching member 2, to attitudes such that they come up against the retainer pieces 11, and cannot pull away from the auxiliary channels 5, and, furthermore, the elastic pieces 14 are formed on the sides of the stud engagement part 9 in a pair at positions 180 degrees apart in the circumferential direction thereof. As a consequence, pulling away is prevented at two places, and retention is definitely maintained, even should the elastic pieces 14 be at the position diagrammed in FIG. 8D (that is, the position where pulling away could occur most easily). Also, in a condition where a cover that is an attaching member is attached to a vehicle body panel that is a member being attached to, even should a force be applied in a direction that would remove the cover because the elastic pieces 14 are up against the rigid retainer pieces 11, the retention thereof is definitely maintained, and the clip 1 will not pull away from the cover.

The stud engagement part 9 is turned 90 degrees from the position diagrammed in FIG. 7, as diagrammed in FIGS. 9 and 10. Thereby, the clip 1 is attached to the attaching member 2 in a condition wherein pulling away is prevented. The elastic pieces 14 are in the attitudes diagrammed in FIGS. 8C and 8D, and by the elastic force thereof, elastically engage the attaching member and provide a force that resists the turning of the stud engagement part 9 about the axis thereof. That turning-resistance force works to prevent the stud engagement part 9 from turning. Accordingly, the securing forces are kept high. Because play in the attaching member 2 clamped between the retainer pieces 11 and flange 10 is prevented, moreover, there is no need to form pressing pieces or turning prevention pieces as in the conventional clips described in Patent Literature 1 or 2. Also, because the elastic pieces only work to elastically press the attaching member toward the flange, a worker is able to handle the force required to turn the stud engagement part and can turn the stud engagement part in the direction of tightening.

FIG. 11 diagrams how an attaching member 2 held by the clip 1 is attached to a member being attached to 6 on which a stud 7, such as a screw-threaded stud, is erected. The attaching work involves only taking the clip 1 attached to the attaching member 2 and pressing it against the member being attached to 6 so that the stud 7 is received in the stud engagement part 9. Engaging pawls 13 of the stud engagement part 9 engage the threaded portion of the stud 7 received in the stud engagement part 9, the clip 1 is attached to the stud 7, and in this way, the attaching member 2 is attached to the member being attached to 6. The flange 10 is provided at the upper end of the stud engagement part 9, the retainer pieces 11 and elastic pieces 14 are provided on the sides of the stud engagement part 9, at positions separated from the flange 10 by a distance corresponding to the thickness of the attaching member, and the stud receiving opening 22 is formed at the lower end of the stud engagement part 9. In this way, the attaching member 2 is clamped by the flange 10, on the one hand, and the retainer pieces 11 and elastic pieces 14, on the other, attachment to the member being attached to 6 is accomplished merely by placing the stud receiving opening of the stud engagement part 9 at the receiving position of the stud 7 and pressing in, and the work of effecting attachment by the stud 7 can easily be accomplished by the operation of pressing the clip 1 into the stud 7 from one side. Furthermore, in the attaching operation, the attaching member 2 can be attached to the member being attached to 6 by, instead of attaching the clip 1 to the attaching member 2 beforehand, deploying the attaching member 2 with the attachment hole thereof positioned at the stud 7 of the member being attached to 6, then pressing in the clip 1 to position it so that the stud 7 is received in the stud engagement part 9 and the retainer pieces 11 pass through the auxiliary channels, and next using the finger grips 21 to turn the stud engagement part 9. After attachment, tightening can be accomplished, in the case of a screw-threaded stud, by turning the stud engagement part 9 using the finger grips 21.

It will be appreciated by persons skilled in the art that the above embodiments have been described by way of example only, and not in any limitative sense, and that various alterations and modifications are possible without departure from the scope of the invention as defined by the appended claims.

What is claimed is:

1. A clip comprising:
a cylindrical stud engagement part for receiving a stud erected on an attaching member and engaging that stud;
a flange provided at an end of said stud engagement part opposite a stud receiving end of said stud engagement part; and
retainer pieces that extend outwardly in the radial direction from positions near said flange of said stud engagement part;
wherein the retainer pieces are formed in such lengths as will pull out from auxiliary channels formed continuously with an attachment hole in the attaching member and extending outwardly in the radial direction thereof, being of such lengths also as will not pull out from said attachment hole;
said clip being configured so as to clamp the attachment member between said retainer pieces and said flange and thereby support the attaching member, and so that the stud engagement part engages the stud and thereby attaches the attaching member to a member being attached to; wherein:
in said retainer pieces, on the sides facing said flange, elastic pieces are formed which extend out diagonally from said retainer pieces toward said flange, which elastic pieces elastically engage the attaching member and present a force that resists the turning of said stud engagement part about the axis thereof.

2. The clip described in claim 1, wherein said retainer pieces are formed as a pair, on the outer circumferential surface of the sides of said stud engagement part, each positioned 180 degrees apart about the outer circumference.

3. The clip described in claim 2, wherein said retainer pieces are formed on the sides of said stud engagement part as plate-form members, each of a length that is shorter than the length of said auxiliary channel, in the circumferential direction; and
wherein said elastic pieces are formed in cantilever shapes such that, in said circumferential direction, each is continuous at one end of said retainer piece, and extends from that one end of said retainer piece toward the other end so as to separate away from that retainer piece and approach said flange.

4. The clip described in claim 3, wherein said elastic pieces are formed so that the length thereof in said circumferential direction is longer than that of said retainer piece and also longer than the width of said auxiliary channel; and
whereupon, when, after said stud engagement part has been inserted into the attachment hole of the attaching member, said retainer pieces have been passed through said auxiliary channels and said flange has been pressed in to a position at which it is flush against the attaching member, said stud engagement part is then turned about the axis thereof, said elastic pieces extending from said retainer pieces come up against the attaching member, the elastic pieces overall furthermore come up against said attaching member, so that they are thus bent in such attitude as to come up against said retainer pieces, and said elastic pieces are held in positions from which they cannot pull out from said auxiliary channels.

5. The clip described in 4, wherein, in said flange, finger grips are formed for turning said stud engagement part about the axis thereof.

6. The clip described in claim 5, wherein said flange is cut out in the areas where said retainer pieces and said elastic pieces are formed, as seen in a plan view of the clip, and said retainer pieces and said elastic pieces can be directly viewed in said plan view.

7. The clip described in claim 6, wherein said flange is provided at the upper end of said stud engagement part;
wherein said retainer pieces and said elastic pieces are provided at the sides of said stud engagement part at positions that are separated from said flange by a distance corresponding to the thickness of the attaching member; and a stud receiving opening is formed at the lower end of said stud engagement part.

8. The clip described in claim 7, wherein said member being attached to is a vehicle body panel, and the attaching member is a cover for covering that panel.

9. A clip comprising:
a stud engagement part configured to receive a stud, the stud engagement part having a first end with a stud receiving opening and a second end with a flange;
wherein a pair of retainer pieces extend from the stud engagement part near the second end of the stud engagement part; and
wherein an elastic piece extends diagonally from an end of the retainer piece, the elastic piece being longer than the retainer piece.

10. The clip of claim 9, wherein the flange comprises two flange portions with spaces between ends of the flange portions; and
wherein the retainer and elastic pieces are located substantially in the area defined by the spaces

11. The clip of claim 10, wherein the retainer pieces are substantially parallel to the flange portions, wherein the elastic pieces extend towards a plane in which the flange lies and wherein ends of the elastic pieces extend beyond the plane of the flange.

12. The clip of claim 11, wherein the clip further comprises ribs which are connected to the stud engagement part and the retainer pieces and serve to support the retainer pieces

13. The clip of claim 12, wherein the clip further comprises finger grips extending axially from the flange pieces.

14. The clip of claim 13, wherein the stud engagement part is substantially cylindrical; and
wherein engagement pawls extend inwardly from an inner circumferential surface of the stud engagement part.

15. A fastener assembly, comprising:
a clip, the clip comprising a stud engagement part configured to receive a stud, the stud engagement part having a first end with a stud receiving opening and a second end with a flange; and
a first member, the first member comprising an attachment hole and auxiliary channels formed continuously with and outwardly in a radial direction from the attachment hole;
wherein a pair of retainer pieces extend from the stud engagement part near the second end of the stud engagement part;
wherein an elastic piece extends diagonally from an end of the retainer piece at least when in a relaxed state, the elastic piece being longer than the retainer piece;
wherein the clip is inserted into the first member with the retainer piece on a first side of the first member and the flange on a second side of the first member; and
wherein the auxiliary channels have a length which is greater than a length of the retainer pieces and which is shorter than a length of the elastic pieces.

16. The fastener assembly according to claim 15, further comprising a second member, the stud attached to and extending from the second member;
wherein the stud is engaged with the stud engagement portion of the clip.

17. The fastener assembly according to claim 16, wherein the attachment hole is generally circular and the auxiliary channels are substantially rectangular shaped channels extending from the circumference of the attachment hole.

18. The fastener assembly according to claim 17, wherein said clip is configured so as to clamp the attachment member between said retainer pieces and said flange; and
wherein the length of the retainer pieces is such that the retainer pieces will pull out from the auxiliary channels and will not pull out from the attachment hole.

19. The fastener assembly according to claim 18, wherein the elastic pieces elastically engage the attaching member and present a force that resists the turning of said stud engagement part about the axis thereof.
